(19) United States
(12) Patent Application Publication
(10) Pub. No.: US 2025/0250480 A1
(43) Pub. Date: Aug. 7, 2025

(54) RECYCLING CHELATING AGENTS AND METHODS RELATED THERETO

(71) Applicant: SAUDI ARABIAN OIL COMPANY, Dhahran (SA)

(72) Inventors: Tariq Abdulsattar ALMUBARAK, Dhahran (SA); Abdulilah AL BAIZ; Mohammed Ali AL YAMI, Dhahran (SA)

(73) Assignee: SAUDI ARABIAN OIL COMPANY, Dhahran (SA)

(21) Appl. No.: 18/433,991

(22) Filed: Feb. 6, 2024

(51) Int. Cl. C09K 8/86; C02F 1/00; C02F 1/66; C02F 5/14; C02F 9/00; C02F 101/38; C02F 103/10; C09K 8/528; C09K 8/54; C09K 8/68; C09K 8/74

(52) U.S. Cl. CPC C09K 8/86; C02F 9/00; C09K 8/528; C09K 8/54; C09K 8/68; C09K 8/74; C02F 1/001; C02F 1/66; C02F 5/14; C02F 2101/38; C02F 2103/10; C02F 2301/08; C09K 2208/32

(57) ABSTRACT

Methods for processing treatment fluids comprising providing a treatment fluid comprising one or more metal-chelating agent complexes; adjusting the pH of the treatment fluid, if necessary, to a pH above about 7, wherein the pH is sufficient to release one or more metal ions from the one or more metal-chelating agent complexes and to precipitate one or more of the released metal ions from the treatment fluid to form one or more precipitated metal hydroxides; separating the precipitated metal hydroxides, if present, from the treatment fluid; lowering the pH of the treatment fluid to a pH of from about 7 to about 4 prior to, concurrently with, and/or after combining the treatment fluid with a scale inhibitor; and lowering the pH of the adjusted treatment fluid to a pH of below about 4. The recycled chelating agents may be used in subsequent subterranean formation operations or a subsequent downstream operations.

### FIELD OF INVENTION

The present disclosure relates to methods for recycling chelating agents utilized in oil and gas treatment fluids, and more particularly, to methods for recycling chelating agents using a combination of pH adjustments and scale inhibitors.

### BACKGROUND

A wellbore in a subterranean formation is often stimulated using a stimulation operation (including enhanced oil recovery options) to produce and/or improve hydrocarbon production therefrom. One method used to stimulate the formation includes acidizing the subterranean formation (e.g., to clean rock pores and increase permeability) through the use of chelating agents, which chelate +2, +3, and +4 metal cations. These metal cations are a cause of concern during such operations due to their limited solubility and ability to cause inorganic precipitation and formation damage (e.g., reduced permeability). Common examples of these metal cations include calcium, magnesium, iron, aluminum, zinc, lead, and mercury. Chelating agents may be used to effectively sequester these problematic metals by forming metal-chelating agent complexes, thereby reducing or eliminating formation damage due to metal cations and other inorganic precipitates (e.g., metal-containing precipitates).

Chelating agents are a broad family of chemicals. Aminopolycarboxylic acids are examples of common chelating agents used in the oilfield. Specific examples of these include aminopolycarboxylic acids such as ethylenediaminetetraacetic acid (EDTA), hydroxyethylenediaminetriacetic acid (HEDTA), diethylenetriaminepentaacetic acid (DTPA), L-glutamic-N,N-diacetic acid (GLDA), methylglycinediacetic acid (MGDA), and nitrilotriacetic acid (NTA). Using chelating agents to chelate metal cations provides opportunities over using other types of chemicals such as acids to address the metal cation issue. Specifically, the potential recyclability of the chelating agents provides an opportunity to reuse the chelating agent through a de-chelation process. A problem with this approach is finding a proper way to de-chelate the chelating agents to recycle them for reuse while maintaining their strength and functionality.

Available methodologies for de-chelating chelating agents include processes that involve electrolysis. However, electrolysis is costly, requiring experienced operators and large-footprint equipment. Moreover, electrolysis can damage the chelating agent molecules, reducing their effectiveness and efficacy for subsequent use.

It is desirable to have an improved chelating agent recycling method that is repeatable, cost-effective, operates using simple equipment, and maintains the integrity of the recycled chelating agents.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one or more aspects, the present disclosure provides a method comprising providing a treatment fluid comprising one or more metal-chelating agent complexes; adjusting the pH of the treatment fluid, if necessary, to a pH above about 7, wherein the pH is sufficient to release one or more metal ions from the one or more metal-chelating agent complexes and to precipitate one or more of the released metal ions from the treatment fluid to form one or more precipitated metal hydroxides; separating the precipitated metal hydroxides, if present, from the treatment fluid; lowering the pH of the treatment fluid to a pH of from about 7 to about 4 prior to, concurrently with, and/or after combining the treatment fluid with a scale inhibitor; lowering the pH of the treatment fluid to a pH of below about 4, wherein the pH is sufficient to release any remaining metal ions from the one or more metal-chelating agent complexes and to precipitate the released chelating agents from the treatment fluid to form recycled chelating agents, while avoiding substantially all precipitation of the released metal ions, and wherein the recycled chelating agents are substantially as effective as the chelating agents at forming the one or more metal-chelating agent complexes; optionally, separating the recycled chelating agent from the treatment fluid to form a separated recycled chelating agent and a separated treatment fluid; optionally, adding the separated recycled chelating agent to a fluid, and using the fluid in a subsequent subterranean formation operation or a subsequent downstream operation to form a treatment fluid comprising one or more metal-chelating agent complexes; and optionally, performing multiple rounds of the method.

Any combinations of the various aspects, embodiments, and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, as will occur to one having ordinary skill in the art and having the benefit of this disclosure.

FIG. 1 shows a method of separating chelating agents from metal cations.

FIG. 2A shows a basic solution of tetrasodium ethylenediaminetetraacetic acid (Na₄-EDTA), F-111 surfactant, and calcium sulfate dihydrate (CaSO₄·2H₂O) in deionized water.

FIG. 2B shows the white precipitate formed in the solution once the solution's pH was dropped to zero (0).

FIG. 2C shows precipitate after filtering and drying it.

FIG. 2D shows reuse testing of the filtered and dried precipitate by being dissolved in deionized water and having the pH raised to 12.6.

FIG. 2E shows the reuse test after 1 day of stirring.

FIG. 3 shows the result of reuse testing from Example 2.

FIG. 4 shows the molecular structures of the tested scale inhibitors.

FIG. 5 shows the cloudy and clear solutions from Example 3 that are labeled #1 through #6.

FIG. 6 shows the clear solutions containing the tested scale inhibitors from Example 4.

FIG. 7 shows the clear and cloudy solutions of the tested scale inhibitors from Example 4.

FIG. 8 shows the clear and cloudy solutions after mixing for 1 hour.

FIG. 9 shows the solutions and precipitates from Example 5.

FIG. 10 shows the solutions and precipitates from Example 6.

### DETAILED DESCRIPTION

As used herein, the term “siliceous,” and grammatical variants thereof, refers to a substance having the characteristics of silica, including silicates, aluminosilicates, and any combination thereof.

As used herein, the term “subterranean formation,” and grammatical variants thereof, refers to naturally occurring rock beneath the Earth's surface, including subsea surfaces. Subterranean formations may be formed from a variety of natural rock including, but not limited to, carbonate-based rock (e.g., calcium carbonate (CaCO₃)), calcium magnesium carbonate (CaMg(CO₃)₂) (also referred to as dolomite), sandstone-based rock comprising clays (e.g., smectite, illite, kaolinite, chlorite, and the like), each of which include minerals (e.g., siliceous material) the like, and any combination thereof. The subterranean formations described herein encompass reservoir zones (i.e., zones comprising hydrocarbons) and non-reservoir zones (i.e., zones that do not include hydrocarbons, such as water-producing zones).

As used herein, the term “subterranean formation operation,” and grammatical variants thereof, refers to any operation involved in the production of hydrocarbons or other fluids, such as water or helium from a subterranean formation (e.g., drilling, completion, stimulation, enhanced recovery, and production). Subterranean formation operations include operations that may be known as upstream operations.

As used herein, the term “wellbore,” and grammatical variants thereof, refers to a drilled hole or borehole penetrating a subterranean formation, which may be cased (cemented) or uncased (open hole).

As used herein, a “downstream operation,” and grammatical variants thereof, refers to a process involved in the conversion of oil and gas to the final finished desired product. Examples include pipeline operations (often referred to as midstream operations) and refining operations that convert crude oil into gasoline, diesel, liquefied natural gas, heating oil, synthetic rubber, plastics, lubricants, and a variety of other products.

As used herein, the term “treatment fluid,” and grammatical variants thereof, refers generally to any fluid that has been used in a subterranean formation operation or a downstream operation for a desired purpose.

As used herein, the term “chelating agent,” and grammatical variants thereof, refers to a chemical compound that forms a metal-chelating agent complex with metal cations by coordinating with these ions with at least one functional group.

As used herein, the term “de-chelating,” and grammatical variants thereof, refers to de-bonding mechanisms that break, destabilize, dissociate, exchange, or otherwise disrupt the bond(s) of a metal-chelating agent complex, thereby releasing the chelating agent and the metal ion from the complex. A “de-chelated chelating agent” is also referred to herein as a “recycled chelating agent”.

The present disclosure relates to methods for recycling chelating agents used in subterranean formation operations and downstream operations, and more particularly, to recycling chelating agents using methods involving pH adjustments and scale inhibitors so that the recycled chelating agents may be reused in a subsequent subterranean formation or downstream operation. Advantageously, the methods described herein are repeatable and cost-effective, operate using simple equipment, and maintain the effectiveness and efficacy of the recycled chelating agents for reuse. The present disclosure also provides chelating agent recycling methods that are operable with the multitude of metal cation types.

In at least one aspect, the present disclosure provides a method comprising providing a treatment fluid comprising one or more metal-chelating agent complexes; adjusting the pH of the treatment fluid, if necessary, to a pH above about 7, wherein the pH is sufficient to release one or more metal ions from the one or more metal-chelating agent complexes and to precipitate one or more of the released metal ions from the treatment fluid to form one or more precipitated metal hydroxides; separating the precipitated metal hydroxides, if present, from the treatment fluid; lowering the pH of the adjusted treatment fluid to a pH of from about 7 to about 4 prior to, concurrently with, and/or after combining the treatment fluid with a scale inhibitor; lowering the pH of the treatment fluid to a pH of below about 4, wherein the pH is sufficient to release any remaining metal ions from the one or more metal-chelating agent complexes and to precipitate the released chelating agent from the treatment fluid to form a recycled chelating agent, while avoiding substantially all precipitation of the released metal ions, and wherein the recycled chelating agent is substantially as effective as the chelating agent at forming the one or more metal-chelating agent complexes; optionally, separating the recycled chelating agent from the treatment fluid to form a separated recycled chelating agent and a separated treatment fluid; optionally, adding the separated recycled chelating agent to a fluid, and using the fluid in a subsequent subterranean formation operation or a subsequent downstream operation to form a treatment fluid comprising one or more metal-chelating agent complexes; and optionally, performing multiple rounds of the method.

A treatment fluid of the present disclosure may comprise a single treatment fluid used in a single subterranean formation operation or a downstream operation or may comprise a mixture of treatment fluids from a plurality of subterranean formation and/or downstream operations. Nonlimiting examples of operations in which a treatment fluid may have been used include an acidizing operation (e.g., an acid washing, a matrix acidizing, or an acid-fracturing operation, or the like, or any combination thereof), a fracturing operation (e.g., an acid-fracturing, a hydraulic fracturing (e.g., a slickwater fracturing), a gravel-packing operation, or the like, or any combination thereof), a scale removal operation (e.g., dissolution or the like, or any combination thereof) (e.g., an inorganic scale removal operation, an organic scale removal operation, or the like, or any combination thereof), a filtercake removal operation, an iron control operation, an enhanced oil recovery operation (e.g., a water, chemical, or gas flooding operation, or the like, or any combination thereof), a surface pipeline treatment, a refinery operation, a water production pipeline operation, or the like, or any combination thereof. A treatment fluid may be from a downstream operation including, but not limited to, an inorganic or organic scale removal operation in pipelines and equipment, a surface pipeline treatment, a corrosion resistance operation in downstream pipelines and equipment, an iron control operation in downstream pipelines and equipment, a refinery operation, or the like, or any combination thereof.

The metal-chelating agent complexes in a treatment fluid may have formed by the interaction of a chelating agent (e.g., EDTA) and a metal cation (e.g., a metal cation present in the subterranean formation, pipeline, or tower). A chelating agent may be capable of chelating different types of metal cations. A chelating agent may be capable of simultaneously chelating multiple metal cations (e.g., a chelating agent may be bidentate, tridentate, tetradentate, pentadentate, hexadentate, heptadentate, or octadentate). A chelating agent may comprise one or more same and/or different chelating agents. A metal-chelating agent complex may comprise one or more same and/or different metal-chelating agent complexes, each metal-chelating agent complex comprising one or more same and/or different chelating agents, each chelating agent chelating one or more same and/or different metal cations.

A metal cation of the present disclosure may include, but is not limited to, from calcium, magnesium, iron, aluminum, zinc, lead, mercury, strontium, barium, and the like, and any combination thereof. The chelating agents in a treatment fluid may have chelated one or more metal cations present in the subterranean formation or downstream operations in which a treatment fluid was used.

A chelating agent of the present disclosure may include, but is not limited to, an aminopolycarboxylic acid, a hydroxycarboxylic acid, an organic acid (e.g., citric or oxalic acid), a phosphonic acid, a polyphosphonic acid, an organophosphonic acid, a crown ether, a macrocycle (e.g., cylam and calixarenes), a polyamine (e.g., triethylenetetramine), a salt thereof (e.g., a phosphonate, a polyphosphonate, an organophosphonate), and the like, and any combination thereof. As recognized by one skilled in the art with the benefit of this disclosure, the chelating properties of aminopolycarboxylates may be engineered by varying the groups linking the nitrogen atoms so as to increase selectivity for a particular metal cation. The number of carbon atoms between the nitrogen and carboxyl groups can also be varied and substituents can be placed on these carbon atoms.

Examples of suitable chelating agents include, but are not limited to, ethylenediaminetetraacetic acid (EDTA), tetrasodium ethylenediaminetetraacetic acid (Na₄-EDTA), hydroxyethylenediaminetriacetic acid (HEDTA), diethylenetriaminepentaacetic acid (DTPA), L-glutamic-N,N-diacetic acid (GLDA), methylglycinediacetic acid (MGDA), nitrilotriacetic acid (NTA), hydroxyethyliminodiacetic acid (HEIDA), cyclohexylenediaminetetraacetic acid (CDTA), diphenylaminesulfonic acid (DPAS), ethylenediaminedi (o-hydroxyphenylacetic) acid (EDDHA), glucoheptonic acid, gluconic acid, citric acid, tetrasodium aspartate diacetate (Na₄-ASDA), ethylenediamine-N,N′-disuccinic acid (EDDS), and the like, salts thereof, and any combination thereof.

The chelating agents may be present in a treatment fluid in an amount ranging from about 1% by weight (wt %) to about 30 wt %, based on the weight of a treatment fluid, and encompassing any value and subset therebetween, such as in the range of about 1 wt % to about 4 wt %, or about 4 wt % to about 8 wt %, or about 8 wt % to about 12 wt %, or about 12 wt % to about 16 wt %, or about 16 wt % to about 20 wt %, or about 20 wt % to about 24 wt %, or about 24 wt % to about 30 wt %, or about 14 wt % to about 16 wt %, or about 15 wt %. The particular concentration of chelating agents present in treatment fluid may depend on a number of factors including, but not limited to, the operation being performed with a treatment fluid, and more particularly, various dissolution mechanisms including pH and steric hindrance.

The following methods for recycling chelating agents may be performed on treatment fluids comprising one or more metal-chelating agent complexes.

The methods include adjusting the pH of a treatment fluid, if necessary, to a pH above about 7 (e.g., from about 7 to about 14, including all pH values and subsets therebetween), where the pH is sufficient to release one or more metal ions from the one or more metal-chelating agent complexes and to precipitate one or more of the released metal ions from a treatment fluid to form one or more precipitated metal hydroxides.

Whether a pH above about 7 is sufficient to release one or more metal ions from the one or more metal-chelating agent complexes and to precipitate one or more of the released metal ions from a treatment fluid to form one or more precipitated metal hydroxides depends on the metal ion species sought to be precipitated out of a treatment fluid. A person of ordinary skill in the art could determine the species of metal ion in a treatment fluid, at what pH each metal ion species would precipitate out as a metal hydroxide, and then adjust the pH of a treatment fluid to that level by adding bases to a treatment fluid.

In some instances, adjusting the pH of a treatment fluid, if necessary, to a pH of above about 7 includes raising the pH of a treatment fluid to a pH of from about 9 to about 14, about 10 to about 14, about 11 to about 14, about 12 to about 14, about 10 to about 13, about 11 to about 13, about 12 to about 13, about 12.3 to about 12.9, or about 12.6.

The methods may include wherein, when adjusting the pH of a treatment fluid, if necessary, to a pH above about 7, includes adding bases or basic buffers to a treatment fluid. Suitable bases and basic buffers for increasing the pH of a treatment fluid include organic bases, inorganic bases, salts thereof, basic mixtures thereof with conjugate acids thereof, and the like, and any combination thereof. Examples of suitable bases for raising the pH include, but are not limited to, sodium or potassium or ammonium hydroxides, sodium or potassium or ammonium carbonates, sodium or potassium or ammonium bicarbonates, salts thereof, basic mixtures thereof with conjugate acids thereof, and the like, and any combination thereof. Examples of suitable buffers include basic carbonate/bicarbonate mixtures, amines, or the like. A treatment fluid may be combined with reaction inhibitors or other additives, e.g., iron control agents, corrosion inhibitors, and the like.

After adjusting the pH of a treatment fluid, if necessary, to a pH above about 7, the methods include separating the precipitated metal hydroxides, if present, from a treatment fluid. Separation processes used in this disclosure may include clarification, filtration, centrifugation, decanting, aspiration, the like, or any combination thereof. The term “clarification,” and grammatical variations thereof as used herein, refers to processes where precipitates and/or solid materials are separated from a solution in a clarifier by gravity and then removed from the clarifier by mechanical means. The term “aspiration,” and grammatical variations thereof as used herein, refers to processes where precipitates and/or solid materials are separated from a solution by means of suction.

After separating the precipitated metal hydroxides, if present, from a treatment fluid, the methods may include lowering the pH of a treatment fluid to a pH of from about 7 to about 4, including all pH values and subsets therebetween (e.g., from about 6 to about 5, from about 6 to about 4, from about 5 to about 4, from about 6 to about 5, about 6, or about 5).

In one embodiment, the pH of a treatment fluid is lowered by the addition of an acid or an acidic buffer to a treatment fluid. Suitable acids and acidic buffers for lowering the pH may comprise inorganic acids, organic acids, acidic mixtures thereof with conjugate bases thereof, and any combination thereof. Examples of suitable acids and acidic buffers include, but are not limited to, hydrochloric acid (HCl), sulfuric acid (H₂SO₄), phosphoric acid (H₃PO₄), nitric acid (HNO₃), acetic acid (CH₃COOH), citric acid (C₆H₈O₇), formic acid (HCOOH), lactic acid (C₃H₆O₃), and the like, an acidic mixture thereof with a conjugate base thereof, and any combination thereof.

The methods include combining a treatment fluid with a scale inhibitor. The pH of a treatment fluid may be lowered to a pH of from about 7 to about 4 prior to, concurrently with, and/or after combining the treatment fluid and a scale inhibitor.

Suitable scale inhibitors may include organophosphonic acids, aminophosphonic acids, phosphate esters, polyacrylic acids, carboxylic acids, polycarboxylic acids, polyphosphoric acids, polymaleic acids, polysulfonic acids, polyaspartic acids, salts thereof, esters thereof (e.g., polyacrylates, sulfonated polyacrylic acids, sulfonated polyacrylates, polycarboxylates, polyphosphates, polymaleates, polysulfonates, polyaspartates, and the like), derivatives thereof, and the like, and any combination thereof.

Suitable examples of organophosphonic acids may include hydroxyethylidene diphosphonic acid (HEDP or etidronic acid), 2-phosphonobutane 1,2,4-tricarboxylic acid (PBTC), or the like, or any combination thereof. Suitable aminophosphonates may include diethylenetriamine penta(methylene phosphonic acid) (DTPMP or DETPMP), amino trimethylene phosphonic acid (ATMP), hexamethylene diamine tetramethylene phosphonic acid (HDTMP), ethylenediamine tetra(methylene phosphonic acid) (EDTMP), hydroxyethylamino bis(methylene phosphonic acid) (HEBMP), bis-hexamethylenetriamine-penta(methylene phosphonic acid) (BHPMP), nitrilotri(methylphosphonic acid) (NTMP), or the like, or any combination thereof. Suitable polyphosphates may include tripolyphosphate salts such as sodium tripolyphosphate and hexametaphosphate salts such as sodium hexametaphosphate. The scale inhibitors may include salts or acids of the mentioned compounds. The scale inhibitors may be added to a treatment fluid at a concentration ranging from about 1 gallons per thousand gallons (gpt) to about 10 gpt, including all gpt values and ranges therebetween (e.g., about 5 gpt).

After the scale inhibitors are added to a treatment fluid, the methods further include lowering the pH of a treatment fluid to a pH of below about 4, wherein the pH is sufficient to release any remaining metal ions from the one or more metal-chelating agent complexes and to precipitate the released chelating agents from the treatment fluid to form recycled chelating agents, while avoiding substantially all precipitation of the released metal ions, and wherein the recycled chelating agents are substantially as effective as the chelating agents at forming the one or more metal-chelating agent complexes.

Whether a pH of below about 4 is sufficient to release any remaining metal ions from the one or more metal-chelating agent complexes and to precipitate the released chelating agents from a treatment fluid to form recycled chelating agents depends on the metal ion species sought to be precipitated out of a treatment fluid. A person of ordinary skill in the art could determine the metal ion species present in a treatment fluid, at what pH the chelating agent would release the metal ions and precipitate from the treatment fluid to form a recycled chelating agent, while the released metal ion species would remain in solution, and then lower the pH of the treatment fluid to that level by adding acids to the treatment fluid.

In some instances, lowering the pH of a treatment fluid to a pH of below about 4 includes lowering the pH of a treatment fluid to a pH of from about 4 to about 0, including all pH values and subsets therebetween (e.g., from about 3 to about 0, from about 2 to about 0, from about 1 to about 0, from about 3 to about 1, from about 2 to about 1, from about 1.8 to about 1.5, or about 1.8).

The phrase “avoiding substantially all precipitation of the released metal ions,” means that substantially all of the metal ions that are released from the metal-chelating agent complexes at a pH of below about 4 remain soluble in a treatment fluid. In some instances, about 95 percent (%) of the released metal ions remain soluble in a treatment fluid; in some instances, about 98% of the released metal ions remain soluble in a treatment fluid; and in some instances, about 100% of the released metal ions remain soluble in a treatment fluid.

The phrase “wherein the recycled chelating agent is substantially as effective as the chelating agent at forming the one or more metal-chelating agent complexes” means that the recycled chelating agents will have substantially the same effectiveness as the chelating agents if they are used in a fluid in a subsequent subterranean formation operation or downstream operation. The methods may include wherein the recycled chelating agents are 95 percent (%) as effective or greater (e.g., from about 95% to about 100%, including all % values and subsets therebetween) as the chelating agent at forming the one or more metal-chelating agent complexes (e.g., 98% or greater, 99% or greater, or 100%).

The methods may not separate the precipitated metal hydroxides, if present, from the treatment fluid. The methods may further use the treatment fluid comprising the recycled chelating agent in a subsequent subterranean formation operation or a subsequent downstream operation to form a treatment fluid comprising one or more metal-chelating agent complexes.

The methods may include separating a precipitated recycled chelating agent from the treatment fluid. This may be performed by the separation methods as previously described above. The methods may include adding a recycled chelating agent to a fluid and using the fluid in one or more subsequent subterranean formation operations and/or subsequent downstream operations. A fluid may be any fluid suitable for use in a subterranean formation operation or a downstream operation. A fluid may be aqueous based. Aqueous bases include fresh water, saltwater, brine, seawater, wastewater, purified wastewater, the like, or any combination thereof. A fluid may include various components such as surfactants, gelling agents, corrosion inhibitors, fluid loss control additives, and proppant particulates, as well as others known in the art that are suitable for the particular subterranean formation operations or downstream operations. The methods may include performing multiple rounds of the disclosed methods for generating recycled chelating agents.

The methods may include increasing the pH of the treatment fluid separated from the precipitated recycled chelating agent to precipitate one or more minerals (e.g., one or more metal salts, e.g., calcium sulfate, or the like) from the treatment fluid. In some instances, the pH of the treatment fluid is increased by adding bases or basic buffers. In some instances, methods include separating the precipitated minerals and the treatment fluid (e.g., to form separated precipitated minerals (e.g., for use in the agricultural industry)). The methods may include reusing the treatment fluid separated from the precipitated recycled chelating agent (e.g., before and/or after further minerals have been precipitated and separated from the treatment fluid). Such a reused treatment fluid may be reused in a fluid, e.g., a fluid for use in a subsequent subterranean formation operation or downstream operation, e.g., a fluid into which a recycled chelating agent is added.

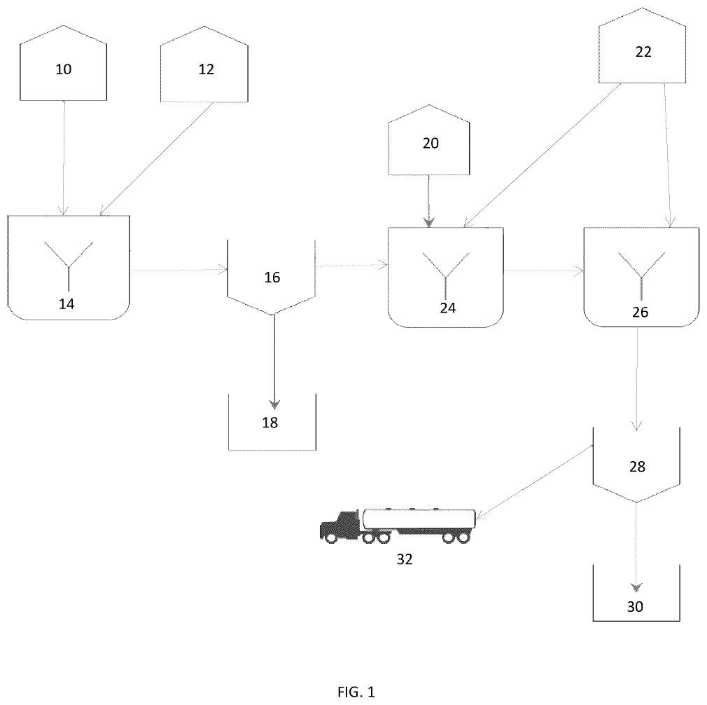

FIG. 1 shows an embodiment of the previously described methods.

A treatment fluid comprising one or more metal-chelating agent complexes from treatment fluid source 10 may be added to first mixer 14, and, if necessary, combined therein with bases from base source 12 to adjust the pH of the treatment fluid to a pH of above about 7, e.g., to a range of from about 9 to about 14. This may release one or more metal ions from the one or more metal-chelating agent complexes and precipitate one or more of the released metal ions from the treatment fluid to form one or more precipitated metal hydroxides.

The treatment fluid and the one or more precipitated metal hydroxides may be added to first separator 16 and separated from one another therein. The separated metal hydroxides from first separator 16 may be collected in metal hydroxide collector 18.

The separated treatment fluid from first separator 16 (“first separated treatment fluid”) may be added to second mixer 24 and combined therein with acids or acidic buffers from acid source 22 to lower the pH to a pH of from about 7 to about 4. Prior to, concurrently with, or after the combination of the treatment fluid and the acids or the acidic buffers, the treatment fluid may be combined in second mixer 24 with scale inhibitors from scale inhibitor source 20.

The treatment fluid from second mixer 24 may be added to third mixer 26 and combined therein with acids or acidic buffers from acid source 22 to lower the pH of the treatment fluid to a pH of below about 4. This may release any remaining metal ions from the one or more metal-chelating agent complexes and precipitate the released chelating agents from the treatment fluid to form recycled chelating agents. The treatment fluid and the precipitated recycled chelating agents from third mixer 26 may be added to second separator 28 and separated therein. The separated recycled chelating agents from second separator 28 may be collected in recycled chelating agent collector 30 for subsequent use, disposal, or storage. The treatment fluid from third mixer 26 or the separated treatment fluid from second separator 28 (“second separated treatment fluid”) may be collected in treatment fluid collector 32 for recycle, subsequent use, storage, or disposal.

The pH of the separated treatment fluid from second separator 28 (e.g., after collection in treatment fluid collector 32) may be increased by the addition of a base or basic buffer to precipitate minerals such as calcium sulfate. The precipitated minerals maybe separated from the treatment fluid. The separated minerals may be used for other industries such as the agricultural industry. The treatment fluid before and/or after the further precipitation of minerals may be reused in a fluid, e.g., a fluid for use in a subsequent subterranean formation operation or downstream operation, e.g., a fluid into which a recycled chelating agent is added.

The methods of the present disclosure provide simple solutions for field personnel performing subterranean formation operations who desire to reuse chelating agents. Moreover, the methods described herein do not hinder or otherwise alter the functionality of the original chelating agents, therefore allowing high performance of the chelating agents in subsequent treatment operations. Further, the methods of the present disclosure do not require costly characterization equipment or laboratory analysis.

While various embodiments have been shown and described herein, modifications may be made by one skilled in the art without departing from the scope of the present disclosure. The embodiments described here are exemplary only, and are not intended to be limiting. Many variations, combinations, and modifications of the embodiments disclosed herein are possible and are within the scope of the disclosure. Accordingly, the scope of protection is not limited by the description set out above, but is defined by the claims which follow that scope including all equivalents of the subject matter of the claims.

### EXAMPLE EMBODIMENTS

Embodiments disclosed herein include:

Embodiment A: a method comprising: (a) providing a treatment fluid comprising one or more metal-chelating agent complexes; (b) adjusting the pH of the treatment fluid, if necessary, to a pH above about 7, wherein the pH is sufficient to release one or more metal ions from the one or more metal-chelating agent complexes and to precipitate one or more of the released metal ions from the treatment fluid to form one or more precipitated metal hydroxides; (c) separating the precipitated metal hydroxides, if present, from the treatment fluid; (d) lowering the pH of the adjusted treatment fluid to a pH of from about 7 to about 4; (c) combining the treatment fluid with a scale inhibitor, wherein step (d) is performed prior to, concurrently with, and/or after step (c); (f) lowering the pH of the treatment fluid to a pH of below about 4, wherein the pH is sufficient to release any remaining metal ions from the one or more metal-chelating agent complexes and to precipitate the released chelating agent from the treatment fluid to form a recycled chelating agent, while avoiding substantially all precipitation of the released metal ions, and wherein the recycled chelating agent is substantially as effective as the chelating agent at forming the one or more metal-chelating agent complexes; (g) optionally, separating the recycled chelating agent from the treatment fluid to form a separated recycled chelating agent and a separated treatment fluid; and optionally, adding the separated recycled chelating agent to a fluid, and using the fluid in a subsequent subterranean formation operation or a subsequent downstream operation to form a treatment fluid comprising one or more metal-chelating agent complexes; and (h) optionally, performing multiple rounds of the method.

Embodiment B: a method comprising: (a) providing a treatment fluid comprising one or more metal-chelating agent complexes; (b) adjusting the pH of the treatment fluid, if necessary, to a pH above about 7, wherein the pH is sufficient to release one or more metal ions from the one or more metal-chelating agent complexes and to precipitate one or more of the released metal ions from the treatment fluid to form one or more precipitated metal hydroxides; (c) separating the precipitated metal hydroxides, if present, from the treatment fluid; (d) lowering the pH of the adjusted treatment fluid to a pH of from about 7 to about 4; (c) combining the treatment fluid with a scale inhibitor, wherein step (d) is performed prior to, concurrently with, and/or after step (c); and (f) lowering the pH of the treatment fluid to a pH of below about 4, wherein the pH is sufficient to release any remaining metal ions from the one or more metal-chelating agent complexes and to precipitate the released chelating agent from the treatment fluid to form a recycled chelating agent, while avoiding substantially all precipitation of the released metal ions, wherein the recycled chelating agent is substantially as effective as the chelating agent at forming the one or more metal-chelating agent complexes.

Each of embodiments A and/or B may have one or more of the following additional elements in any combination:

Element 1: wherein the one or more metal-chelating agent complexes comprise calcium, magnesium, iron, aluminum, zinc, lead, mercury, strontium, or barium cations, or any combination thereof.

Element 2: wherein, in step (a), adjusting the pH of the treatment fluid, if necessary, to a pH of above about 7 comprises raising the pH of the treatment fluid to a pH of from about 12 to about 14.

Element 3: wherein, in step (a), adjusting the pH of the treatment fluid, if necessary, to a pH above about 7 comprises adding a base or a basic buffer to the treatment fluid.

Element 4: wherein, in step (d) lowering the pH of the treatment fluid to a range pH of from about 7 to about 4 comprises lowering the pH of the treatment fluid to a pH of from about 6 to about 5.

Element 5: wherein, in step (f), lowering the pH of the adjusted treatment fluid to a pH of below about 4 comprises lowering the pH of the treatment fluid to a pH of from about 2 to about 1.

Element 6: wherein, in step (d), lowering the pH of the adjusted treatment fluid to a pH of from about 7 to about 4 and/or, in step (f), lowering the pH of the adjusted treatment fluid to a pH of below about 4 comprises adding an acid or an acidic buffer to the treatment fluid.

Element 7: wherein the chelating agent comprises an aminopolycarboxylic acid, a salt thereof, or any combination thereof.

Element 8: wherein the chelating agent comprises ethylenediaminetetraacetic acid (EDTA), hydroxyethylenediaminetriacetic acid (HEDTA), methylglycenediacetic acid (MGDA), diethylenetriaminepentaacetic acid (DTPA), L-glutamic-N,N-diacetic acid (GLDA), nitrilotriacetic acid (NTA), a salt thereof, or any combination thereof.

Element 9: wherein the scale inhibitor comprises a phosphate-based, a phosphonate-based, an amino phosphonate-based, a polyacrylic acid-based, a sulfonated polyacrylic acid-based, or a carboxylic acid-based scale inhibitor, a salt thereof, or any combination thereof.

Element 10: wherein the scale inhibitor comprises diethylenetriamine penta(methylene phosphonic acid) (DTPMP), hexamethylene diamine tetramethylene phosphonic acid (HDTMP), or ethylenediamine tetra(methylene phosphonic acid) (EDTMP), a salt thereof, or any combination thereof.

Element 11: wherein, in step (c), separating the precipitated metal hydroxides, if present, from the treatment fluid and/or separating the recycled chelating agent from the treatment fluid comprises clarification, filtration, centrifugation, decanting, aspiration, or any combination thereof.

Element 12: wherein the recycled chelating agent is 100 percent (%) as effective as the chelating agent at forming the one or more metal-chelating agent complexes.

Element 13: wherein, in step (g), separating the recycled chelating agent from the treatment fluid is not performed, and wherein the method further comprises: using the treatment fluid comprising the recycled chelating agent in a subsequent subterranean formation operation or a subsequent downstream operation to form a treatment fluid comprising one or more metal-chelating agent complexes.

Element 14: wherein step (g) is performed and further comprises: adjusting the pH of the treatment fluid to a pH above about 7, wherein the pH is sufficient to precipitate one or more of the released metal ions from the treatment fluid to form one or more precipitated metal hydroxides; and separating the one or more precipitated metal hydroxides, if present, from the treatment fluid.

Element 15: wherein step (g) further comprises: adding the separated recycled chelating agent to the treatment fluid separated from the one or more precipitated metal hydroxides, if present, and using the treatment fluid in a subsequent subterranean formation operation or a subsequent downstream operation to form a treatment fluid comprising one or more metal-chelating agent complexes.

Element 16: wherein, in step (g), the subterranean formation operation or the subsequent downstream operation comprises an acidizing operation, a fracturing operation, a scale removal operation, a filtercake removal operation, a corrosion resistance operation, an iron control operation, a surface pipeline treatment, a refinery operation, a water production pipeline operation, or any combination thereof.

To facilitate a better understanding of the aspects of the present disclosure, the following examples of preferred or representative aspects are given. In no way should the following examples be read to limit, or to define, the scope of the disclosure.

### EXAMPLES

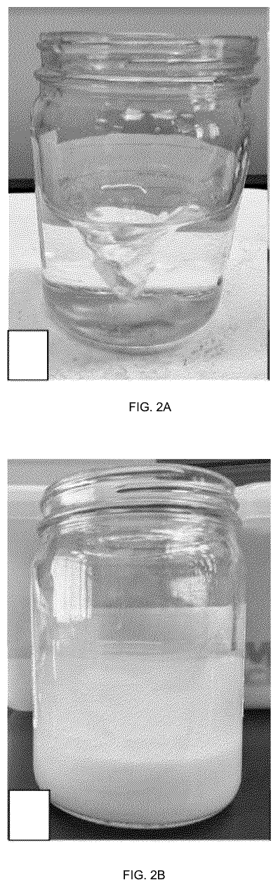

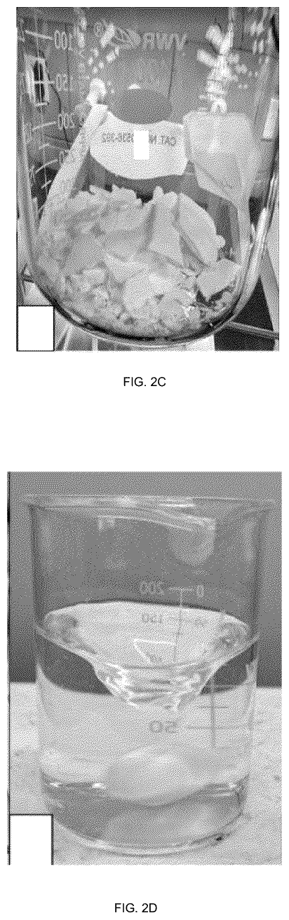

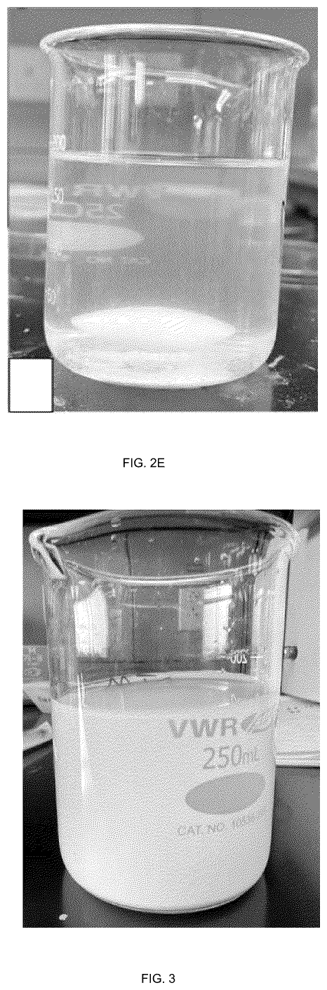

EXAMPLE 1: (Comparative) In this Example, a treatment fluid was prepared comprising 11.5 grams (g) of 99% Na₄-EDTA dissolved in 150 milliliters (mL) of de-ionized (DI) water. A water-wetting surfactant “F-111” (commercially available from Schlumberger, Texas) was added to the treatment fluid in an amount of 1 (gpt). The pH of the treatment fluid was adjusted to approximately 12.6 using a combination of KHCO₃ and 7 molar KOH, which were completely dissolved in the treatment fluid to form a solution. Then 4 g of CaSO₄·2H₂O (calcium sulfate dihydrate) was added to the solution to simulate the treatment fluid. As shown in FIG. 2A, the solution was then stirred using a magnetic stirrer until all solids were dissolved. Once the solids were completely dissolved, HCl was added to reduce the pH of the solution to approximately 0. As shown in FIG. 2B, a large amount of white precipitate formed. The precipitate was stirred for approximately 60 minutes and then filtered using a WHATMAN® #2 filter paper (commercially available from Sigma-Aldrich, Missouri). The filtered solid was then collected, dried, and prepared for reuse. The filtered and dried solid is shown in FIG. 2C.

As shown in FIG. 2D, for reuse testing, the filtered solid was dissolved in 150 ml deionized water and the pH was raised to approximately 12.6 using 7 molar KOH. Once the solution reached that target pH, 4 g of calcium sulfate dihydrate was added to the solution once again. As shown in FIG. 2E, the solution was left in the stirrer for over 1 day, but the solids did not completely dissolve therein. A duplicate run was conducted to determine the exact amount of calcium sulfate dihydrate that can be re-dissolved with this method. The duplicate run dissolved 3.2 g of calcium sulfate dihydrate. Taking the ratio of 3.2 g versus the 4.0 g that was previously dissolved, it was determined that the recovered EDTA efficiency was ˜80% with this method.

It is believed that this Example 1 showcases the downside of acidifying EDTA to a pH of 0 because of its inability to completely dissolve the same amount of calcium sulfate a second time. See FIGS. 2A through 2E. This may indicate either (a) the presence of impurities in the final EDTA or (b) the weakening of the chelating agents after recovery. It was noted that EDTA has a buffering influence when it is dropping out of solution at a pH<2.88. A new process was attempted by acidifying the solution to a pH between 1-2. Most preferably a pH of 1.5-1.8 was used.

EXAMPLE 2: (Comparative) A similar procedure was conducted but with the difference in making the extraction pH at 1.8 instead of 0 and white precipitate again collected. The white precipitate was reuse tested again, and the EDTA efficiency was ˜50%. In this Example 2, 11.5 g of 99% tetra sodium ethylenediaminetetraacetic acid (Na₄-EDTA) was dissolved in 150 ml deionized water. A water wetting surfactant “F-111” was added at a concentration of 1 gpt. The pH of the solution was raised to 12.6 using a combination of KHCO₃ and 7 molar KOH to completely dissolve the EDTA in solution. When the solution reached that pH, 4 g of calcium sulfate dihydrate was added to the solution. The solution was stirred with a magnetic stirrer until the solids were fully dissolved. Once completely dissolved, HCl was added to reduce the pH of the solution to approximately 1.8 (as opposed to 0 in Example 1). It was observed that the solution kept buffering, and therefore, kept adding HCl to maintain until the approximately 1.8 pH was stable for 1 hour. A white precipitate formed, which was filtered out using WHATMAN® #2 filter paper (commercially available from Sigma-Aldrich, Missouri). The solid was then collected, dried, and prepared for reuse. The filtered solid was dissolved in 150 ml deionized water and the pH of the solution was raised to approximately 12.6 using 7 molar KOH. Once at that pH, 4 g of calcium sulfate dihydrate was added to the solution once again. The solution was left in the stirrer for over 1 day, but the solids were not completely dissolved. A duplicate run was conducted to determine the exact amount of calcium sulfate dihydrate that can be re-dissolved with this process, and it was determined that the recovered EDTA efficiency was approximately 50% with this method. The final re-use result is shown in FIG. 3, which shows a substantially cloudy solution.

It is believed that Example 2 showcases the downside of acidifying EDTA to pH 1.8 because of its inability to completely dissolve the same amount of calcium sulfate a second time. It is beneficial to reduce the amount of acids used to reduce pH when extracting EDTA. Reducing the pH to 1.8, therefore, is more cost effective than reducing it to pH 0.

The inability to completely dissolve calcium sulfate in both Examples 1 and 2 may be due to the precipitate being a combination of both EDTA and re-precipitated calcium sulfate. To prevent the precipitation of calcium sulfate during EDTA acidification, a calcium sulfate scale inhibitor may be used if stable at the requisite pH levels.

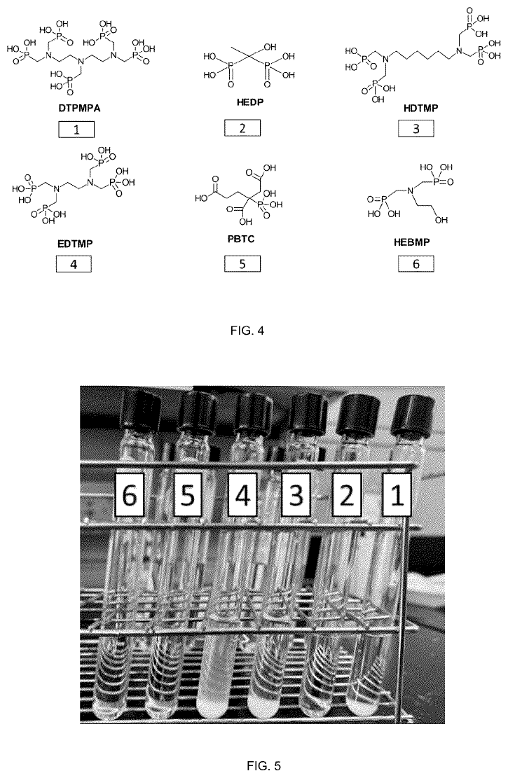

EXAMPLE 3: Multiple phosphate and phosphonate-based molecules were screened to identify suitable scale inhibitors. The scale inhibitors tested were diethylenetriamine penta(methylene phosphonic acid) (DTPMP), hydroxyethylidene diphosphonic acid (HEDP or etidronic acid), hexamethylene diamine tetramethylene phosphonic acid (HDTMP), ethylenediamine tetra(methylene phosphonic acid) (EDTMP), 1,2,4-tricarboxylic acid (PBTC), and hydroxyethylamino bis(methylene phosphonic acid) (HEBMP). The scale inhibitors are shown in FIG. 4 and are labeled 1 through 6. It was observed that these molecules generally did not perform well at low pH levels. This can clearly be seen when the molecules were mixed with a solution of HCl to achieve pH 0. FIG. 5 shows that precipitate formed for test tubes containing DTPMP, HDTMP, and EDTMP but not for test tubes containing HEDP, PBTC, and HEBMP.

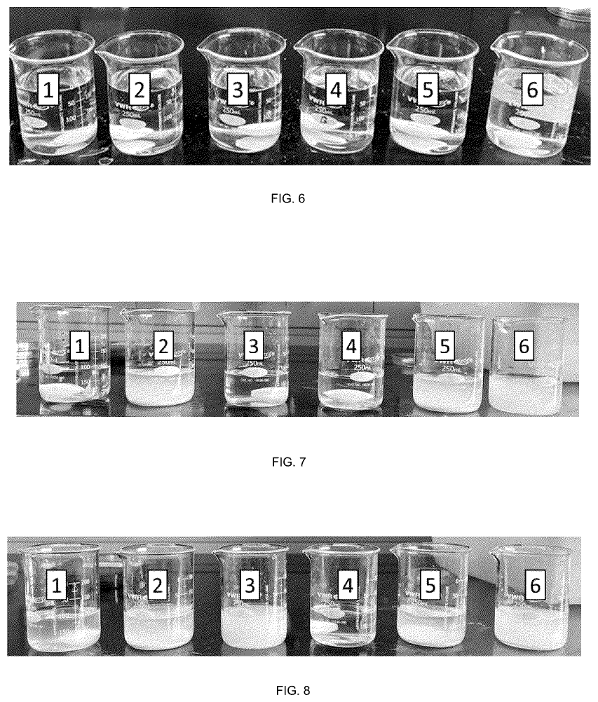

EXAMPLE 4: The same molecules from Example 3 were then tested for the ability to prevent calcium sulfate scale. They were added at a concentration of 5 gpt to a solution of 6,000 ppm Ca²⁺ and 13,000 ppm SO₄ at a pH of approximately 5-6 (adjusted using HCl/KOH). As shown in FIG. 6, all solutions containing the different molecules remained clear, thus giving an indication that these molecules successfully work as calcium sulfate scale inhibitors at a pH level of approximately 5-6.

After that the pH was reduced to 1.8 and the DTPMP, HDTMP, and EDTMP solutions showed clear cases, indicating their ability to prevent calcium sulfate scale at that pH level. FIG. 7 shows that DTPMP, HDTMP, and EDTMP were clear solutions while HEDP, PBTC, and HEBMP were cloudy.

All of the solutions were then mixed for 60 minutes, and only the EDTMP solution remained clear. This is shown in FIG. 8. This gave an indication that in the absence of EDTA only EDTMP was viable. However, testing was still completed in the presence of EDTA for all inhibitor cases to simulate actual scenarios with all the interfering structures present simultaneously.

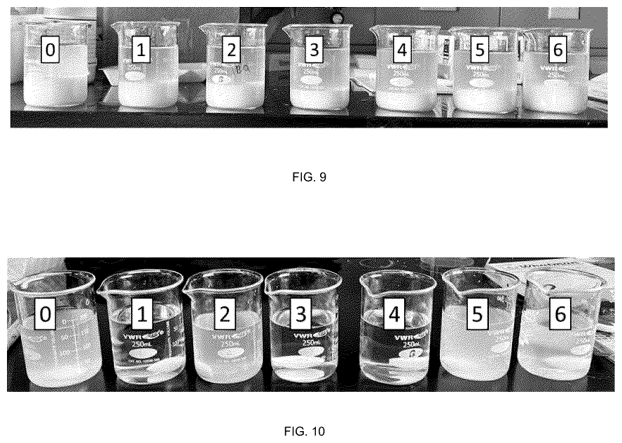

EXAMPLE 5: New 11.5 g EDTA solutions were prepared following the preparation of Examples 1 and 2 where the pH was increased to 12.6 using a combination of potassium bicarbonate and KOH. A water wetting surfactant “F-111” was added at a concentration of 1 gpt and 4 g calcium sulfate dihydrate was also added and dissolved. After dissolving the calcium sulfate dihydrate, the pH of the solutions was reduced to approximately 5-6. Next, the six scale inhibitor types tested in Example 3 were added in separate beakers at concentrations of 5 gpt. A base case was also prepared that had no scale inhibitor. The pH was then dropped to approximately 1.8 and left for 60 minutes. As shown in FIG. 9, all cases formed a white precipitate with the base case forming the most amount of precipitate with visual observation and each case forming a different amount of precipitate. This may indicate that the base case included precipitate of both calcium sulfate and EDTA while the cases with the scale inhibitor showed less precipitate, indicating the possibility that less calcium sulfate was precipitated with EDTA.

The samples were then filtered, the solids were re-dissolved in a new solution of deionized water, and the pH was increased to approximately 12.6 following the procedures explained in Examples 1 and 2. Next, 4 g of calcium sulfate dihydrate was added to the samples to check for efficiency. Surprisingly, the success cases were not limited to the case where EDTMP was added. It was also seen that solutions with DTPMP and HDTMP were also exceptional in dissolving all of the added calcium sulfate dihydrate and producing a clear solution resulting in 100% efficiency. FIG. 10 shows that the base case, and the cases with HEDP, PBTC, and HEBMP were cloudy and the cases with DTPMP, HDTMP, and EDTMP were clear-visually indicating a 100% efficiency for reuse after recovery and extraction. It is also noteworthy to mention that utilizing a pH of approximately 1.5-1.8 as opposed to 0 may result in a lower requirement of chemicals to acidify the solution, reducing incompatibilities of the tested molecules, and increasing its efficiency.

EXAMPLE 6: In this Example 6, 11.5 g of 99% Na₄-EDTA was dissolved in 150 ml deionized water. A water wetting surfactant “F-111” was added at a concentration of 1 gpt. The pH of the solution was raised to approximately 12.6 using a combination of potassium bicarbonate and 7 molar KOH to completely dissolve the EDTA in the solution. 4 g of calcium sulfate dihydrate was added to the solution. The solution was stirred with a magnetic stirrer until the solids were fully dissolved. Once completely dissolved, the pH was dropped to a level of approximately 5-6, and then EDTMP was added to the solution at a concentration of 5 gpt. HCl was then added to reduce the pH to 1.8. At this point, it was observed that the solution kept buffering, which required the addition of more HCl to maintain this pH stable for at least 60 minutes. A white precipitate formed and was filtered out using WHATMAN® #2 filter paper. The solid was then collected, dried, and prepared for reuse. The filtered solid was dissolved in 150 ml deionized water and the water wetting surfactant (F-111) was added at a concentration of 1 gpt. The pH was raised to approximately 12.6 using a combination of potassium bicarbonate and 7 molar KOH. 4 g of calcium sulfate dihydrate was added to the solution once again. The solution was clear of any precipitate, showing this method to be superior compared to the methods in previous examples discussed above, which lacked the addition of a scale inhibitor. The chelating agents achieved about 100% efficiency in this method. The method was repeated seven times, showing complete dissolution of 4 g of calcium sulfate with the extracted EDTA each time, maintaining this high level of near 100% efficiency. The same experiment was also performed with HDTMP and DTPMP to show their effectiveness, which was also near 100% efficiency. The results can be seen in Table 1 below.

TABLE 1

| | | | | | | | CaSO₄•2H₂O | |
|---|---|---|---|---|---|---|---|---|
| | | | | Dissolved | | EDTA | Dissolved | |
| Test | EDTA | | CaSO₄•2H₂O | Completely | Scale | Extraction | after EDTA | Efficiency |
| # | (g) | pH | (g) | (Yes/No) | Inhibitor | pH | extraction (g) | (%) |
| 1 | 11.5 | 12.6 | 4 | Yes | None | 0 | 3.2 | 80 |
| 2 | 11.5 | 12.6 | 4 | Yes | None | 1.8 | 2 | 50 |
| 3 | 11.5 | 12.6 | 4 | Yes | EDTMP | 1.8 | 4 | 100 |
| 4 | 11.5 | 12.6 | 4 | Yes | EDTMP | 1.8 | 4 | 100 |
| 5 | 11.5 | 12.6 | 4 | Yes | EDTMP | 1.8 | 4 | 100 |
| 6 | 11.5 | 12.6 | 4 | Yes | EDTMP | 1.8 | 4 | 100 |
| 7 | 11.5 | 12.6 | 4 | Yes | EDTMP | 1.8 | 4 | 100 |
| 8 | 11.5 | 12.6 | 4 | Yes | EDTMP | 1.8 | 4 | 100 |
| 9 | 11.5 | 12.6 | 4 | Yes | EDTMP | 1.8 | 4 | 100 |
| 10 | 11.5 | 12.6 | 4 | Yes | EDTMP | 1.8 | 4 | 100 |
| 11 | 11.5 | 12.6 | 4 | Yes | HDTMP | 1.8 | 4 | 100 |
| 12 | 11.5 | 12.6 | 4 | Yes | HDTMP | 1.8 | 4 | 100 |
| 13 | 11.5 | 12.6 | 4 | Yes | HDTMP | 1.8 | 4 | 100 |
| 14 | 11.5 | 12.6 | 4 | Yes | DTPMP | 1.8 | 4 | 100 |
| 15 | 11.5 | 12.6 | 4 | Yes | DTPMP | 1.8 | 4 | 100 |
| 16 | 11.5 | 12.6 | 4 | Yes | DTPMP | 1.8 | 4 | 100 |

Accordingly, the present disclosure provides for effective methods for recycling chelating agents.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized that these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled,” or “coupled to,” or “connected,” or “connected to,” or “attached,” or “attached to” may indicate establishing either a direct or indirect connection and are not limited to either unless expressly referenced as such.

While the disclosure has described several exemplary embodiments, it will be understood by those skilled in the art that various changes can be made, and equivalents can be substituted for elements thereof without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure, as described herein. Accordingly, the scope of the disclosure should be limited only by the attached claims.

As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that also contemplated is the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed is:

1. A method comprising:
(a) providing a treatment fluid comprising one or more metal-chelating agent complexes;
(b) adjusting the pH of the treatment fluid, if necessary, to a pH above 7, wherein the pH is sufficient to release one or more metal ions from the one or more metal-chelating agent complexes and to precipitate one or more of the released metal ions from the treatment fluid to form one or more precipitated metal hydroxides;
(c) separating the precipitated metal hydroxides, if present, from the treatment fluid;
(d) lowering the pH of the treatment fluid to a pH of from below 7 to about 4;
(e) combining the treatment fluid with a scale inhibitor, wherein step (d) is performed prior to, concurrently with, and/or after step (e);
(f) lowering the pH of the treatment fluid to a pH of below about 4, wherein the pH is sufficient to release any remaining metal ions from the one or more metal-chelating agent complexes and to precipitate the released chelating agent from the treatment fluid to form a recycled chelating agent, while avoiding substantially all precipitation of the released metal ions, and wherein the recycled chelating agent is substantially as effective as the chelating agent at forming the one or more metal-chelating agent complexes;
(g) optionally, separating the recycled chelating agent from the treatment fluid, adding the recycled chelating agent to a fluid, and using the fluid in a subsequent subterranean formation operation or a subsequent downstream operation to form a treatment fluid comprising one or more metal-chelating agent complexes; and
(h) optionally, performing multiple rounds of steps (a) through (g).

2. The method of claim 1, wherein the one or more metal-chelating agent complexes comprise calcium, magnesium, iron, aluminum, zinc, lead, mercury, strontium, or barium cations, or any combination thereof.

3. The method of claim 1, wherein, in step (a), adjusting the pH of the treatment fluid, if necessary, to a pH of above 7 comprises raising the pH of the treatment fluid to a pH of from about 12 to about 14.

4. The method of claim 1, wherein, in step (a), adjusting the pH of the treatment fluid, if necessary, to a pH above 7 comprises adding a base or a basic buffer to the treatment fluid.

5. The method of claim 1, wherein, in step (d) lowering the pH of the treatment fluid to a pH of from below 7 to about 4 comprises lowering the pH of the treatment fluid to a pH of from about 6 to about 5.

6. The method of claim 1, wherein, in step (f), lowering the pH of the treatment fluid to a pH of below about 4 comprises lowering the pH of the treatment fluid to a pH of from about 2 to about 1.

7. The method of claim 1, wherein, in step (d), lowering the pH of the treatment fluid to a pH of from below 7 to about 4 and/or, in step (f), lowering the pH of the treatment fluid to a pH of below about 4 comprises adding an acid or an acidic buffer to the treatment fluid.

8. The method of claim 1, wherein the chelating agent comprises an aminopolycarboxylic acid, a salt thereof, or any combination thereof.

9. The method of claim 8, wherein the chelating agent comprises ethylenediaminetetraacetic acid (EDTA), hydroxyethylenediaminetriacetic acid (HEDTA), methylglycenediacetic acid (MGDA), diethylenetriaminepentaacetic acid (DTPA), L-glutamic-N,N-diacetic acid (GLDA), nitrilotriacetic acid (NTA), a salt thereof, or any combination thereof.

10. The method of claim 1, wherein the scale inhibitor comprises a phosphate-based, a phosphonate-based, an amino phosphonate-based, a polyacrylic acid-based, a sulfonated polyacrylic acid-based, or a carboxylic acid-based scale inhibitor, a salt thereof, or any combination thereof.

11. The method of claim 1, wherein the scale inhibitor comprises diethylenetriamine penta(methylene phosphonic acid) (DTPMPA), hexamethylene diamine tetramethylene phosphonic acid (HDTMP), ethylenediamine tetra(methylene phosphonic acid) (EDTMP), a salt thereof, or any combination thereof.

12. The method of claim 1, wherein, in step (c), separating the precipitated metal hydroxides, if present, from the treatment fluid and/or, in step (g), separating the recycled chelating agent from the treatment fluid comprises clarification, filtration, centrifugation, decanting, aspiration, or any combination thereof.

13. The method of claim 1, wherein the recycled chelating agent is 100 percent (%) as effective as the chelating agent at forming the one or more metal-chelating agent complexes.

14. The method of claim 1, wherein, in step (g), separating the recycled chelating agent from the treatment fluid is not performed, and wherein the method further comprises: using the treatment fluid comprising the recycled chelating agent in a subsequent subterranean formation operation or a subsequent downstream operation to form a treatment fluid comprising one or more metal-chelating agent complexes.

15. The method of claim 1, wherein step (g) is performed and further comprises: adjusting the pH of the treatment fluid to a pH above about 7, wherein the pH is sufficient to precipitate one or more of the released metal ions from the treatment fluid to form one or more precipitated metal hydroxides; and separating the one or more precipitated metal hydroxides, if present, from the treatment fluid.

16. The method of claim 15, wherein step (g) further comprises: adding the separated recycled chelating agent to the treatment fluid separated from the one or more precipitated metal hydroxides, if present, and using the treatment fluid in a subsequent subterranean formation operation or a subsequent downstream operation to form a treatment fluid comprising one or more metal-chelating agent complexes.

17. The method of claim 1, wherein, in step (g), the subterranean formation operation or the subsequent downstream operation comprises an acidizing operation, a fracturing operation, a scale removal operation, a filtercake removal operation, a corrosion resistance operation, an iron control operation, a surface pipeline treatment, a refinery operation, a water production pipeline operation, or any combination thereof.

18. A method comprising:
(a) providing a treatment fluid comprising one or more metal-chelating agent complexes;
(b) adjusting the pH of the treatment fluid, if necessary, to a pH above 7, wherein the pH is sufficient to release one or more metal ions from the one or more metal-chelating agent complexes and to precipitate one or more of the released metal ions from the treatment fluid to form one or more precipitated metal hydroxides;
(c) separating the precipitated metal hydroxides, if present, from the treatment fluid;
(d) lowering the pH of the treatment fluid to a pH of from below 7 to about 4;
(e) combining the treatment fluid with a scale inhibitor, wherein step (d) is performed prior to, concurrently with, and/or after step (e); and
(f) lowering the pH of the treatment fluid to a pH of below about 4, wherein the pH is sufficient to release any remaining metal ions from the one or more metal-chelating agent complexes and to precipitate the released chelating agent from the treatment fluid to form a recycled chelating agent, while avoiding substantially all precipitation of the released metal ions, and wherein the recycled chelating agent is substantially as effective as the chelating agent at forming the one or more metal-chelating agent complexes.

19. The method of claim 18, wherein the chelating agent comprises ethylenediaminetetraacetic acid (EDTA), hydroxyethylenediaminetriacetic acid (HEDTA), methylglycenediacetic acid (MGDA), diethylenetriaminepentaacetic acid (DTPA), L-glutamic-N,N-diacetic acid (GLDA), nitrilotriacetic acid (NTA), a salt thereof, or any combination thereof.

20. The method of claim 19, wherein the scale inhibitor comprises a phosphate-based, a phosphonate-based, an amino phosphonate-based, a polyacrylic acid-based, a sulfonated polyacrylic acid-based, or a carboxylic acid-based scale inhibitor, a salt thereof, or any combination thereof.
